(19) United States
(12) Patent Application Publication
(10) Pub. No.: US 2017/0207732 A1
(43) Pub. Date: Jul. 20, 2017

(54) CYCLIC POWER GENERATING DEVICE

(71) Applicant: Chiung-Hao CHEN, Tainan City (TW)

(72) Inventors: Chiung-Hao CHEN, Tainan City (TW); Hsin-Hung LIU, Tainan City (TW)

(21) Appl. No.: 15/262,419

(22) Filed: Sep. 12, 2016

(30) Foreign Application Priority Data
Jan. 14, 2016 (TW) 105200522

(51) Int. Cl. H02P 1/16; H02J 7/04; H02J 7/00

(52) U.S. Cl. CPC H02P 1/16; H02J 7/0052; H02J 7/0063; H02J 7/04

(57) ABSTRACT

A cyclic power generating device includes: a start control module operable to generate driving power according to DC supply power, and generating a control signal; a power generating apparatus operable, based on the control signal, to convert the driving power into mechanical power components, and converting the mechanical power components into AC recycling power and a power output; an input module providing charging power based on at least one of the AC recycling power and AC input power; and an energy storage module using the charging power to increase at least one of stored energy components stored therein, and releasing at least one of the stored energy components to provide the DC supply power.

### CROSS-REFERENCE TO RELATED APPLICATION

This application claims priority of Taiwanese Patent Application No. 105200522, filed on Jan. 14, 2016.

### FIELD

The disclosure relates to a power generating device, and more particularly to acyclic power generating device capable of recycling energy.

### BACKGROUND

A conventional movable power generating device disadvantageously consumes a relatively large amount of fuel such as diesel fuel or gasoline to generate electricity.

### SUMMARY

Therefore, an object of the disclosure is to provide a cyclic power generating device that can alleviate the drawback of the prior art.

According to the disclosure, the cyclic power generating device includes a start control module, a power generating apparatus, an input module and an energy storage module. The start control module receives a power ON/OFF signal that indicates whether to output power, a start signal that indicates whether to start power conversion, and DC (direct current) supply power. The start control module is operable, based on the power ON/OFF signal, to generate driving power according to the DC supply power, and generates a control signal based on the start signal. The power generating apparatus is coupled to the start control module for receiving the driving power and the control signal therefrom. The power generating apparatus is operable, based on the control signal, to convert the driving power into a plurality of mechanical power components in an electrical to mechanical manner. The power generating apparatus converts the mechanical power components into AC (alternating current) recycling power and a power output, which includes at least one of DC output power and AC output power, in a mechanical to electrical manner. The input module is coupled to the power generating apparatus for receiving the AC recycling power therefrom, is used to further receive AC input power, and provides charging power based on at least one of the AC recycling power and the AC input power. The energy storage module is coupled to the input module and the start control module, and receives the charging power from the input module. The energy storage module stores a plurality of stored energy components, uses the charging power to increase at least one of the stored energy components, and releases one of the stored energy components to provide the DC supply power for the start control module.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an embodiment of a cyclic power generating device according to the disclosure;

FIG. 2 is a block diagram illustrating a DC (direct current) generating module of the embodiment; and

FIG. 3 is a block diagram illustrating a second energy storage module of the embodiment.

### DETAILED DESCRIPTION

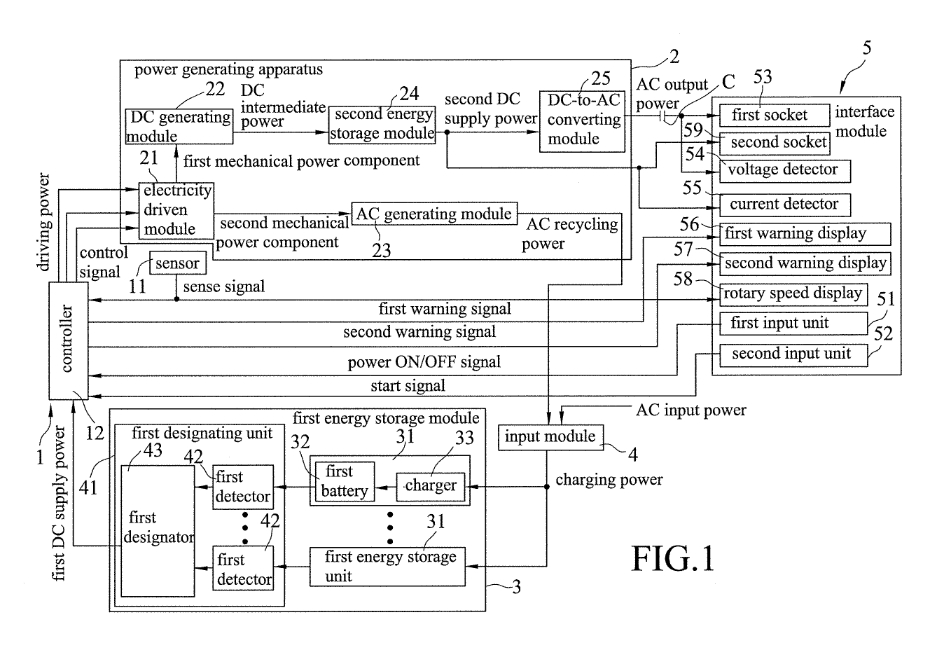

Referring to FIG. 1, an embodiment of a cyclic power generating device according to the disclosure is movable, and includes a start control module 1, a power generating apparatus 2, an input module 4, a first energy storage module 3, a capacitor (C) and an interface module 5.

The start control module 1 receives a power ON/OFF signal that indicates whether to output power, a start signal that indicates whether to start power conversion, and first DC (direct current) supply power. The start control module 1 is operable, based on the power ON/OFF signal, to generate driving power according to the first DC supply power, and generates a control signal based on the start signal. The driving power is generated when the power ON/OFF signal indicates to output power, and is not generated when the power ON/OFF signal indicates not to output power.

The power generating apparatus 2 is coupled to the start control module 1 for receiving the driving power and the control signal therefrom. The power generating apparatus 2 is operable, based on the control signal, to convert the driving power into a plurality of mechanical power components in an electrical to mechanical manner. Conversion of the driving power is performed when the control signal corresponds to the start signal indicating to start power conversion, and is not performed when the control signal corresponds to the start signal indicating not to start power conversion. The power generating apparatus 2 converts the mechanical power components into AC (alternating current) recycling power and a power output, which includes DC output power and AC output power, in a mechanical to electrical manner.

The input module 4 is coupled to the power generating apparatus 2 for receiving the AC recycling power therefrom, is used to further receive AC input power, and provides charging power based on at least one of the AC recycling power and the AC input power.

The first energy storage module 3 is coupled to the input module 4 and the start control module 1, and receives the charging power from the input module 4. The first energy storage module 3 stores a plurality of first stored energy components, uses the charging power to increase at least one of the first stored energy components, and releases at least one of the first stored energy components to provide the first DC supply power for the start control module 1.

In this embodiment, the input module 4 outputs the AC recycling power to serve as the charging power when receiving the AC recycling power, and outputs the AC input power to serve as the charging power when not receiving the AC recycling power. Therefore, the charging power is AC charging power.

In this embodiment, the first energy storage module 3 includes a plurality of first energy storage units 31 and a first designating unit 41.

The first energy storage units 31 are coupled to the input module 4 for cooperatively receiving the AC charging power therefrom. Each first energy storage unit 31 stores a respective first stored energy component, and is operable to use the received AC charging power to increase the respective first stored energy component. In this embodiment, each first energy storage unit 31 includes a first battery 32 and a charger 33. For each first energy storage unit 31, the first battery 32 stores the respective first stored energy component; the charger 33 is coupled to the input module 4 for receiving at least a portion of the AC charging power therefrom, and is coupled further to the first battery 32; and the charger 33 is operable to convert the received AC charging power into a respective DC charging power component, and use the DC charging power component to charge the first battery 32 so as to increase the first stored energy component stored in the first battery 32. For example, each charger 33 starts to use the received AC charging power to charge the respective first battery 32 when a residual electrical quantity of the respective first battery 32 is less than a predetermined lower limit value, and stops using the received AC charging power to charge the respective first battery 32 when the residual electrical quantity of the respective first battery 32 is greater than a predetermined upper limit value.

The first designating unit 41 is coupled to the first batteries 32 and the start control module 1, and detects the respective residual electrical quantities of the first batteries 32. The first designating unit 41 designates, based on the detected residual electrical quantities, at least one of the first batteries 32 to release the first stored energy component stored there in through the first designating unit 41 so as to provide the first DC supply power for the start control module 1. In this embodiment, the first designating unit 41 includes a plurality of first detectors 42 and a first designator 43. Each first detector 42 is coupled to a respective first battery 32, and detects the residual electrical quantity of the respective first battery 32 to generate a respective first detection signal that indicates the detected residual electrical quantity. Each first detector 42 may further display the detected residual electrical quantity, such that relevant personnel can easily know the residual electrical quantity of the respective first battery 32. The first designator 43 is coupled to the first detectors 42 and the start control module 1, and receives the first detection signals respectively from the first detectors 42. The first designator 43 designates, based on the detected residual electrical quantities respectively indicated by the first detection signals, at least one of the first batteries 32 to release the first stored energy component stored therein through the respective first detector 42 and the first designator 43 so as to provide the first DC supply power for the start control module 1. For example, the first designator 43 designates one of the first batteries 32, the detected residual electrical quantity of which is greater than the predetermined lower limit value, to release the first stored energy component stored therein. When the detected residual electrical quantity of said one of the first batteries 32 is less than the predetermined lower limit value, the first designator 43 designates another one of the first batteries 32, the detected residual electrical quantity of which is greater than the predetermined lower limit value, to release the first stored energy component stored therein.

As a result, each first battery 32 may have a relatively long lifetime. It is noted that, when the detected residual electrical quantities of the first batteries 32 are all less than the predetermined lower limit value, none of the first batteries 32 is designated to release the first stored energy component stored therein, the first DC supply power is not provided, the driving power and the AC recycling power are not generated, and the input power is outputted to serve as the charging power for charging the first batteries 32. When the detected residual electrical quantity of at least one of the first batteries 32 is greater than the predetermined lower limit value, one of the at least one of the first batteries 32 is designated to release the first stored energy component stored therein, the first DC supply power is provided, the driving power and the AC recycling power may be generated, and the AC recycling power may be outputted to serve as the charging power for charging the first batteries 32.

Referring to FIGS. 1 to 3, in this embodiment, the power generating apparatus 2 includes an electricity driven module 21, a DC generating module 22, an AC generating module 23, a second energy storage module 24 and a DC-to-AC converting module 25.

The electricity driven module 21 is coupled to the start control module 1 for receiving the driving power and the control signal therefrom. The electricity driven module 21 is operable, based on the control signal, to convert the driving power into the mechanical power components that includes a first mechanical power component and a second mechanical power component.

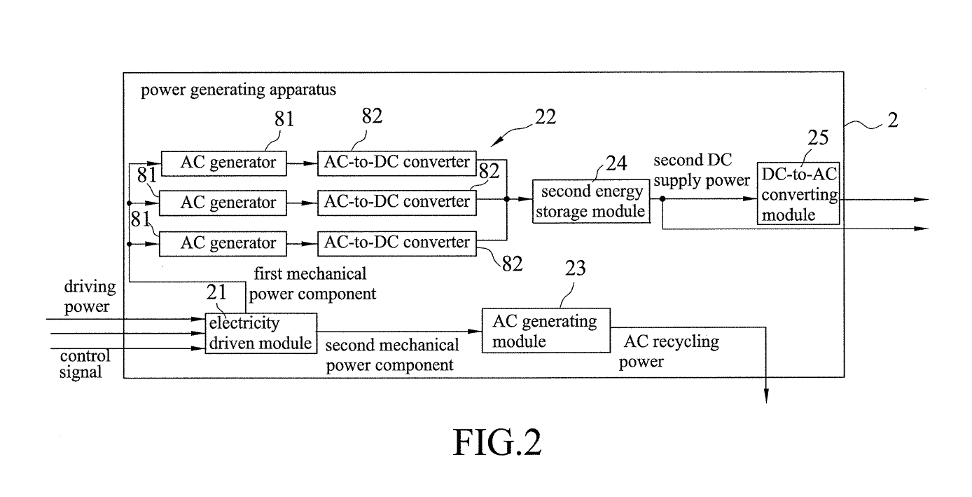

The DC generating module 22 is coupled to the electricity driven module 21 for receiving the first mechanical power component therefrom, and converts the first mechanical power component into DC intermediate power. In this embodiment, the DC generating module 22 includes a number (N) of AC generators 81 and a number (N) of AC-to-DC converters 82, where N≧1 (e.g., N=3 in FIG. 2). The AC generators 81 are coupled to the electricity driven module 21 for cooperatively receiving the first mechanical power component therefrom, and cooperatively convert the first mechanical power component to respectively generate a number (N) of AC intermediate power components. The AC-to-DC converters 82 are coupled respectively to the AC generators 81 for receiving the AC intermediate power components respectively therefrom, and are coupled further to the second energy storage module 24. The AC-to-DC converters 82 respectively convert the AC intermediate power components to cooperatively generate the DC intermediate power for the second energy storage module 24. It is noted that each of the AC generators 81 and the AC-to-DC converters 82 endures a current stress that decreases with increasing N.

The AC generating module 23 is coupled to the electricity driven module 21 and the input module 4, receives the second mechanical power component from the electricity driven module 21, and converts the second mechanical power component into the AC recycling power for the input module 4.

In this embodiment, each of the electricity driven module 21, the DC generating module 22 and the AC generating module 23 includes a respective gear (not shown). The electricity driven module 21 uses the driving power to drive the gear thereof to rotate, such that the driving power is converted into the first mechanical power component that drives the gear of the DC generating module 22 to rotate, and the second mechanical power component that drives the gear of the AC generating module 23 to rotate.

The second energy storage module 24 is coupled to the AC-to-DC converters 82 for receiving the DC intermediate power therefrom. The second energy storage module 24 stores a plurality of second stored energy components, uses the DC intermediate power to increase at least one of the second stored energy components, and releases at least one of the second stored energy components to provide second DC supply power.

In this embodiment, the second energy storage module 24 includes a plurality of second energy storage units 6 and a second designating unit 7.

The second energy storage units 6 are coupled to the AC-to-DC converters 82 for cooperatively receiving the DC intermediate power therefrom. Each second energy storage unit 6 stores a respective second stored energy component, and is operable to use the received DC intermediate power to increase the respective second stored energy component. In this embodiment, each second energy storage unit 6 includes a second battery 62 and a voltage regulator 61. For each second energy storage unit 6, the second battery 62 stores the respective second stored energy component; the voltage regulator 61 is coupled to the AC-to-DC converters 82 for receiving at least a portion of the DC intermediate power therefrom, and is coupled further to the second battery 62; and the voltage regulator 61 is operable to regulate a voltage of the received DC intermediate power, and use the regulated DC intermediate power to charge the second battery 62 so as to increase the second stored energy component stored in the second battery 62.

The second designating unit 7 is coupled to the second batteries 62, and detects respective residual electrical quantities of the second batteries 62. The second designating unit 7 designates, based on the detected residual electrical quantities, at least one of the second batteries 62 to release the second stored energy component stored therein through the second designating unit 7 so as to provide the second DC supply power. In this embodiment, the second designating unit 7 includes a plurality of second detectors 72 and a second designator 71. Each second detector 72 is coupled to a respective second battery 62, and detects the residual electrical quantity of the respective second battery 6 to generate a respective second detection signal that indicates the detected residual electrical quantity. The second designator 71 is coupled to the second detectors 72 for receiving the second detection signals respectively therefrom. The second designator 71 designates, based on the detected residual electrical quantities respectively indicated by the second detection signals, at least one of the second batteries 62 to release the second stored energy component stored therein through the respective second detector 72 and the second designator 71 so as to provide the second DC supply power. For example, the second designator 71 designates one of the second batteries 62, the detected residual electrical quantity of which is relatively great, to release the second stored energy component stored therein.

The DC-to-AC converting module 25 is coupled to the second designator 71 for receiving a portion of the second DC supply power therefrom, and converts the portion of the second DC supply power into the AC output power.

Referring to FIG. 1, in this embodiment, the start control module 1 includes a sensor 11 and a controller 12. The sensor 11 senses a rotary speed of the gear of the electricity driven module 21 to generate a sense signal that indicates the sensed rotary speed. The controller 12 is coupled to the first designator 43, the electricity driven module 21 and the sensor 11, receives the power ON/OFF signal and the start signal, and further receives the first DC supply power and the sense signal respectively from the first designator 43 and the sensor 11. The controller 12 is operable, based on the power ON/OFF signal, to generate the driving power according to the first DC supply power, and generates the control signal based on the start signal. The controller 12 controls the electricity driven module 21 based on the sensed rotary speed indicated by the sense signal in such a way that the sensed rotary speed indicated by the sense signal is within a predetermined range, for example, from 3600 rpm to 4000 rpm. The controller 12 further generates a first warning signal when it cannot generate normally the driving power according to the first DC supply power, and a second warning signal when the sensed rotary speed indicated by the sense signal is outside the predetermined range.

The capacitor (C) has a first terminal that is coupled to the DC-to-AC converting module 25, and a second terminal.

The interface module 5 includes a first socket 53, a second socket 59, a first input unit 51, a second input unit 52, a voltage detector 54, a current detector 55, a first warning display 56, a second warning display 57 and a rotary speed display 58.

The first socket 53 is coupled to the second terminal of the capacitor (C) for receiving the AC output power from the DC-to-AC converting module 25 through the capacitor (C), such that a load (not shown) can be powered by the AC output power when coupled to the first socket 53.

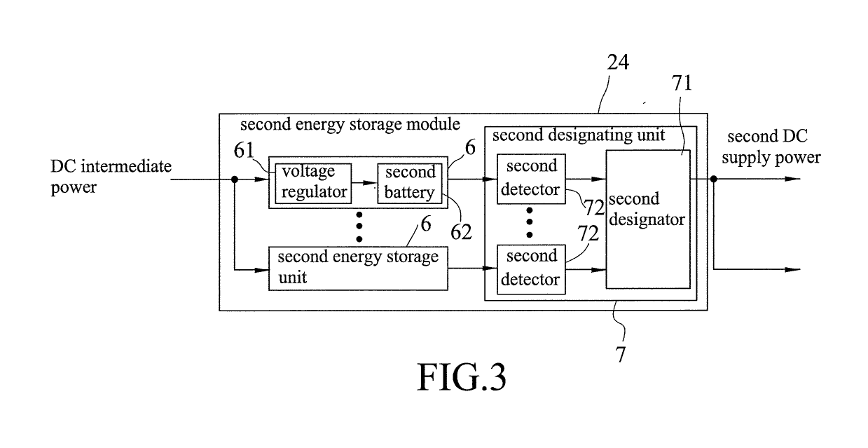

The second socket 59 is coupled to the second designator 71 (see FIG. 3) for receiving another portion of the second DC supply power therefrom to serve as the

DC output power, such that a load (not shown) can be powered by the DC output power when coupled to the second socket 59.

The first input unit 51 is coupled to the controller 12, and is operable to generate the power ON/OFF signal for the controller 12.

The second input unit 52 is coupled to the controller 12, and is operable to generate the start signal for the controller 12.

The voltage detector 54 is coupled to the second terminal of the capacitor (C) for detecting a voltage of the AC output power. The voltage detector 54 may further display the detected voltage, such that relevant personnel can easily know the voltage of the AC output power.

The current detector 55 is coupled to the second designator 71 (see FIG. 3) for detecting a current of the DC output power. The current detector 55 may further display the detected current, such that relevant personnel can easily know the current of the DC output power.

The first warning display 56 is coupled to the controller 12 for receiving the first warning signal therefrom, and emits light when receiving the first warning signal to inform relevant personnel that the controller 12 cannot generate normally the driving power according to the first DC supply power, in order to have the problem resolved in a timely fashion.

The second warning display 57 is coupled to the controller 12 for receiving the second warning signal therefrom, and emits light when receiving the second warning signal to inform relevant personnel that the rotary speed of the gear of the electricity driven module 21 is outside the predetermined range, in order to have the problem resolved in a timely fashion.

The rotary speed display 58 is coupled to the controller 12 for receiving the sense signal therefrom, and displays the sensed rotary speed indicated by the sense signal, such that relevant personnel can easily know the rotary speed of the gear of the electricity driven module 21.

It is noted that, in other embodiments, the following modifications may be made to this embodiment:

1. The power output may include only the AC output power. In this case, the second socket 59 and the current detector 55 may be omitted, and the DC-to-AC converting module 25 may receive all the second DC supply power from the second designator 71 (see FIG. 3).

2. The power output may include only the DC output power. In this case, the DC-to-AC converting module 25, the capacitor (C), the first socket 53 and the voltage detector 54 may be omitted, and the second socket 59 may receive all the second DC supply power from the second designator 71 (see FIG. 3) to serve as the DC output power.

In view of the above, with the first energy storage module 3 using the AC recycling power that serves as the charging power to increase the first stored energy components stored there in and releasing the first stored energy components stored therein to provide the first DC supply power, the cyclic power generating device of this embodiment uses a relatively small amount of the input power, and therefore a relatively small amount of fuel is consumed to generate the input power. It is noted that the cyclic power generating device of this embodiment may cooperate with one or any combination of a wind power generator, a solar power generator, a vehicle power generator and a diesel power generator to supply power.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that the disclosure is not limited to the disclosed embodiment but is intended to cover various arrangements included within the spirit and scope of the broadest interpretation so as to encompass all such modifications and equivalent arrangements.

What is claimed is:

1. A cyclic power generating device comprising:
a start control module receiving a power ON/OFF signal that indicates whether to output power, a start signal that indicates whether to start power conversion, and first DC (direct current) supply power, said start control module being operable, based on the power ON/OFF signal, to generate driving power according to the first DC supply power, and generating a control signal based on the start signal;
a power generating apparatus coupled to said start control module for receiving the driving power and the control signal therefrom, said power generating apparatus being operable, based on the control signal, to convert the driving power into a plurality of mechanical power components in an electrical to mechanical manner, said power generating apparatus converting the mechanical power components into AC (alternating current) recycling power and a power output, which includes at least one of DC output power and AC output power, in a mechanical to electrical manner;
an input module coupled to said power generating apparatus for receiving the AC recycling power therefrom, used to further receive AC input power, and providing charging power based on at least one of the AC recycling power and the AC input power; and
a first energy storage module coupled to said input module and said start control module, and receiving the charging power from said input module, said first energy storage module storing a plurality of first stored energy components, using the charging power to increase at least one of the first stored energy components, and releasing at least one of the first stored energy components to provide the first DC supply power for said start control module.

2. The cyclic power generating device of claim 1, wherein said first energy storage module includes:
a plurality of first energy storage units coupled to said input module for cooperatively receiving the charging power therefrom, each of said first energy storage units storing a respective one of the first stored energy components, and being operable to use the received charging power to increase the respective one of the first stored energy components; and
a first designating unit coupled to said first energy storage units and said start control module, and detecting respective residual electrical quantities of said first energy storage units, said first designating unit designating, based on the detected residual electrical quantities, at least one of said first energy storage units to release the first stored energy component stored therein through said first designating unit so as to provide the first DC supply power for said start control module.

3. The cyclic power generating device of claim 2, wherein the charging power is AC charging power, and each of said first energy storage units includes:
a first battery storing the respective one of the first stored energy components; and
a charger coupled to said input module for receiving at least a portion of the AC charging power therefrom, and coupled further to said first battery, said charger being operable to convert the received AC charging power into a respective DC charging power component, and use the DC charging power component to charge said first battery so as to increase the first stored energy component stored in said first battery.

4. The cyclic power generating device of claim 2, wherein said first designating unit includes:
a plurality of first detectors, each of which is coupled to a respective one of said first energy storage units, and each of which detects the residual electrical quantity of the respective one of said first energy storage units to generate a respective first detection signal that indicates the detected residual electrical quantity; and
a first designator coupled to said first detectors and said start control module, and receiving the first detection signals respectively from said first detectors, said first designator designating, based on the detected residual electrical quantities respectively indicated by the first detection signals, at least one of said first energy storage units to release the first stored energy component stored therein through the respective one of said first detectors and said first designator so as to provide the first DC supply power for said start control module.

5. The cyclic power generating device of claim 1, wherein said power generating apparatus includes:
an electricity driven module coupled to said start control module for receiving the driving power and the control signal therefrom, said electricity driven module being operable, based on the control signal, to convert the driving power into the mechanical power components that includes a first mechanical power component and a second mechanical power component;
a DC generating module coupled to said electricity driven module for receiving the first mechanical power component therefrom, and converting the first mechanical power component into DC intermediate power;
a second energy storage module coupled to said DC generating module for receiving the DC intermediate power therefrom, said second energy storage module storing a plurality of second stored energy components, using the DC intermediate power to increase at least one of the second stored energy components, and releasing at least one of the second stored energy component to provide second DC supply power for the power output; and
an AC generating module coupled to said electricity driven module and said input module, receiving the second mechanical power component from said electricity driven module, and converting the second mechanical power component into the AC recycling power for said input module.

6. The cyclic power generating device of claim 5, wherein said second energy storage module includes:
a plurality of second energy storage units coupled to said DC generating module for cooperatively receiving the DC intermediate power therefrom, each of said second energy storage units storing a respective one of the second stored energy components, and being operable to use the received DC intermediate power to increase the respective one of the second stored energy components; and
a second designating unit coupled to said second energy storage units, and detecting respective residual electrical quantities of said second energy storage units, said second designating unit designating, based on the detected residual electrical quantities, at least one of said second energy storage units to release the second stored energy component stored therein through said second designating unit so as to provide the second DC supply power.

7. The cyclic power generating device of claim 6, wherein each of said second energy storage units includes:
a second battery storing the respective one of the second stored energy components; and
a voltage regulator coupled to said DC generating module for receiving at least a portion of the DC intermediate power therefrom, and coupled further to said second battery, said voltage regulator being operable to regulate a voltage of the received DC intermediate power, and use the regulated DC intermediate power to charge said second battery so as to increase the second stored energy component stored in said second battery.

8. The cyclic power generating device of claim 6, wherein said second designating unit includes:
a plurality of second detectors, each of which is coupled to a respective one of said second energy storage units, and each of which detects the residual electrical quantity of the respective one of said second energy storage units to generate a respective second detection signal that indicates the detected residual electrical quantity; and
a second designator coupled to said second detectors for receiving the second detection signals respectively therefrom, said second designator designating, based on the detected residual electrical quantities respectively indicated by the second detection signals, at least one of said second energy storage units to release the second stored energy component stored therein through the respective one of said second detectors and said second designator so as to provide the second DC supply power.

9. The cyclic power generating device of claim 5, wherein said DC generating module includes:
a number (N) of AC generators coupled to said electricity driven module for cooperatively receiving the first mechanical power component therefrom, and cooperatively converting the first mechanical power component to respectively generate a number (N) of AC intermediate power components, where N≧1; and
a number (N) of AC-to-DC converters coupled respectively to said AC generators for receiving the AC intermediate power components respectively there from, and coupled further to said second energy storage module, said AC-to-DC converters respectively converting the AC intermediate power components to cooperatively generate the DC intermediate power for said second energy storage module.

10. The cyclic power generating device of claim 5, wherein said start control module includes:
a sensor sensing a rotary speed of said electricity driven module to generate a sense signal that indicates the sensed rotary speed; and
a controller coupled to said first energy storage module, said electricity driven module and said sensor, receiving the power ON/OFF signal and the start signal, and further receiving the first DC supply power and the sense signal respectively from said first energy storage module and said sensor, said controller being operable, based on the power ON/OFF signal, to generate the driving power according to the first DC supply power, and generating the control signal based on the start signal, said controller controlling said electricity driven module based on the sensed rotary speed indicated by the sense signal in such a way that the sensed rotary speed indicated by the sense signal is within a predetermined range.

11. The cyclic power generating device of claim 5, wherein said power generating apparatus further includes:
a DC-to-AC converting module coupled to said second energy storage module for receiving at least a portion of the second DC supply power therefrom, and converting the received second DC supply power into the AC output power.

12. The cyclic power generating device of claim 11, further comprising:
a capacitor having a first terminal that is coupled to said DC-to-AC converting module, and a second terminal; and
an interface module including a first socket that is coupled to said second terminal of said capacitor for receiving the AC output power from said DC-to-AC converting module through said capacitor.

13. The cyclic power generating device of claim 12, wherein said interface module further includes a second socket that is coupled to said second energy storage module for receiving another portion of the second DC supply power therefrom to serve as the DC output power.

14. The cyclic power generating device of claim 13, wherein said interface module further includes:
a first input unit coupled to said start control module, and operable to generate the power ON/OFF signal for said start control module;
a second input unit coupled to said start control module, and operable to generate the start signal for said start control module;
a voltage detector coupled to said second terminal of said capacitor for detecting a voltage of the AC output power; and
a current detector coupled to said second energy storage module for detecting a current of the DC output power.

15. The cyclic power generating device of claim 5, further comprising:
an interface module including a second socket that is coupled to said second energy storage module for receiving at least a portion of the second DC supply power therefrom to serve as the DC output power.
